(19) United States
(12) Patent Application Publication
(10) Pub. No.: US 2008/0135376 A1
(43) Pub. Date: Jun. 12, 2008

(54) Escalator or Moving Walkway

(76) Inventors: Uwe Hauser, Nienburg (DE); Ernest Fuhring, Lindhorst (DE); Rainer Schmidt, Lindhorst (DE); Michael Kroske, Lauenhagen (DE); Klaus Seehausen, Niedernwoehren (DE)

Correspondence Address: ROBERT W. BECKER & ASSOCIATES, 707 HIGHWAY 333, SUITE B, TIJERAS, NM, 87059-7507, US

(21) Appl. No.: 11/756,073

(22) Filed: May 31, 2007

(30) Foreign Application Priority Data
May 31, 2006 (DE) 20 2006 009 483.0

(51) Int. Cl. B66B 25/00

(52) U.S. Cl. 198/322

(57) ABSTRACT

An escalator or a moving walkway having a plurality of steps or panels which are each guided on rails, via running rollers and idling rollers. A distance sensor is integrated in or on the rail and senses, in particular, the deviation in diameter of the running or idling roller running over it.

### BACKGROUND OF THE INVENTION

The invention relates to an escalator or a moving walkway.

The steps of escalators and the panels of moving walkways run on rollers which are guided on rails. Such rails are usually made of metal and have a number of supports over the course of the escalator or of the moving walkway. The supporting locations are spaced apart such that, in the case of admissible maximum loading, the step belt of the escalator or the panel belt of the moving walkway does not move downward by more than a predetermined minimum amount. Apart from the bowing of the rails, downward movement under loading also takes place as a result of the elasticity of the mounting arrangement itself.

This includes, in particular, the rollers on which the steps or panels move, that is to say the idling rollers or the chain rollers. Sliding bearings or rolling-contact bearings, preferably ball bearings, are usually provided for the rotatable mounting of the rollers, and the rollers are mounted on pins which project outwardly beneath the step or panel or to the side of the step or panel. This results in a certain amount of elastic compliance. In addition, the running surface of the rollers is usually provided with an elastic material since the amount of noise produced by the escalator or the moving walkway depends quite critically on the operational noise of the steps or panels.

Numerous tests have been carried out in order to optimize the running surfaces of the rollers, the so-called roller covers: a greater material thickness for the roller covers results in easier compression, and thus in correspondingly more pronounced downward movement of the step belt under loading.

On the other hand, a thicker roller cover readily makes it possible to reduce the operational noise to a considerable extent.

The type, elasticity and strength of the material used are also critical for the rolling properties of the rollers of the escalator or of the moving walkway. Use has been made here, up until now, of various elastomers or plastics, polyurethane having proven particularly successful on account of the particular abrasion resistance.

Special emphasis is indeed often placed nowadays on acceptance considerations in respect of escalators or moving walkways, in which case, in addition to a pleasing appearance, smooth, uniform and quiet operation of the escalator is also considered to be particularly important for sales purposes.

However, it is precisely soft roller covers, thus allowing more or less noise-free operation, which, in addition to being susceptible to abrasion, are also particularly susceptible to damage. It is thus often the case, for safety purposes, that use is made of roller covers with a greater hardness, in which case attempts are made to provide the desired elasticity properties by making the roller covers thicker.

However, the tests which have been carried out in conjunction with the invention show that it is precisely thick roller covers which are extremely susceptible to damage. They also require better lateral guidance and are less stable as far as absorbing lateral loads is concerned. In many cases, they therefore require additional lateral guidance, which increases the costs of the design as a whole and makes it more susceptible to disruption.

On the other hand, an escalator or a corresponding moving walkway which is less expensive, and nevertheless operates smoothly, would be very desirable.

In order to achieve this, experiments have been carried out with various materials for the roller covers. It has thus been proposed, for example, to use polyurethane instead of a rubber mixture. With appropriate selection of the roller-cover thickness, this actually results in smooth operation being achieved to good effect, in which case in particular the structure-borne sound absorption of the comparatively thick polyurethane roller cover is advantageous for smooth operation.

In contrast, the object of the invention is to provide an escalator or a moving walkway of the aforementioned general type which is distinguished by particularly smooth operation, but nevertheless has more favorable operating costs.

### SUMMARY OF THE INVENTION

The invention provides for an escalator or a moving walkway to be equipped, on the rail in each case, with a distance sensor which is directed toward the running roller or idling roller. The distance sensor can then senses directly on the rail, the state of the relevant roller which is currently running over the rail and, in this respect, can establish if there is any damage present which makes it necessary to exchange the roller.

This means, on the other hand, that, rather than rollers having to be exchanged prematurely and for safety reasons exchange only ever has to be carried out when the roller cover has actually been damaged.

In this respect, there is no need to plan regular safety-related exchange cycles, and this reduces the operating costs to a considerable extent.

The solution according to the invention, in which the roller covers are monitored via a distance sensor, is extremely cost-effective to produce, robust and reliable. It is only when the relevant roller decreases in diameter that the distance sensor responds, and to be precise in a reliable manner.

According to the invention, it is particularly advantageous in this context if the distance sensor according to the invention is of elongate design, and to be precise such that it responds when a roller is not operating smoothly, that is to say when a roller changes its vertical position as it rotates. According to the invention, it is particularly advantageous in this respect if the vertical displacement which is critical for smooth operation is sensed. Slight damage, for example to the side flank of the roller cover, does not have any effect on the smooth operation and is also not sensed according to the invention.

Such damage can occur for various reasons. For example, foreign bodies may come into contact with the rail and give rise to corresponding damage. The roller cover may be damaged by heating, aging or material fatigue. In exceptional cases, the roller body itself may also rupture; furthermore, it is also possible for the roller cover to become detached from the roller body or for a bearing problem to occur.

All such damage to the roller cover or the roller can be sensed according to the invention since it causes vertical displacement of the roller, this displacement resulting in a change in distance. In practical terms, the distance sensor according to the invention senses a change in distance between the roller axis and rail, in which case, according to the invention, the distance sensor establishes whether the relevant roller is keeping the distance sensor far enough away from the rail over its entire circumference and, in this respect, is undamaged.

While it is readily possible according to the invention for the damage to the roller covers to be sensed in the return run of the installation, it is preferable for the distance sensor according to the invention to be installed in the forward run thereof.

Either sensing can take place over the height of the roller as a whole, in that the distance sensor according to the invention is spaced apart from the rail and arranged opposite the same, as seen in relation to the roller. Alternatively and, in this respect, preferably, it is also possible to provide a curved supporting element which supports the roller at a lateral spacing from the roller cover and, if the roller cover is not damaged, allows the roller to run simultaneously on the curved supporting element and on the rail. In the case of this possibility, the distance sensor will be triggered whenever the diameter of the roller cover is too small at least at one location, as seen over the circumference of the roller cover, since, in this case, the distance between the axis and the outer circumference of the roller is smaller. Of course, in order to avoid wear to the curved supporting element, in addition to the relevant roller, a guard roller is then provided within the step chain, this guard roller running on the curved supporting element and being arranged coaxially in relation to the relevant roller.

A roller according to the invention may be configured in any suitable manner. The roller cover can be realized either from a comparatively soft material, although in this case it has a small height. As an alternative, it is also possible to use a comparatively hard plastic material for the roller cover, this material having a greater overall height. It is then quite possible for the thickness of the roller cover, that is to say the height of the coating of the roller, to be, for example 20% of the roller diameter, or else, in other cases, 2% or 5%,

The material used for the roller cover is preferably a solid plastic material, preferably an elastomer, although thermoplastic materials can also be used. Polyurethane has been found to be particularly advantageous.

As an alternative, however, it is also possible to use a closed-cell plastic with a comparatively small cell size, and a roller cover made of a closed-cell core and a solid running surface is also possible.

It is particularly advantageous if the distance sensor extends parallel to the running direction of the rollers and is integrated into the rail. In this solution, sensing takes place in accordance with the natural running movement of the roller, and the distance sensor is triggered if a defect is present at any desired location of the roller cover. For this purpose, the length of the distance sensor according to the invention corresponds to the circumference of the roller. In this respect, the next-following roller enters into the region of the distance sensor precisely when the previous roller has rolled all the way past the distance sensor.

It is particularly advantageous if successive rollers, for practical purposes, trigger the distance sensor, or hold it down, in an overlapping manner. This ensures that the distance sensor is continuously pushed down without it being possible for triggering to take place between the rollers, the entire circumference of the relevant roller being checked nonetheless.

### BRIEF DESCRIPTION OF THE DRAWINGS

Further advantages, details and features of the present invention can be gathered from the following description of an exemplary embodiment with reference to the drawings, in which:

FIG. 1 shows a schematic sectional view of part of an escalator according to the invention, namely of a rail in section with the distance sensor according to the invention;

FIG. 2 shows a bottom view and a side view of the distance sensor according to the invention; and

FIG. 3 shows an enlarged view of the detail A from FIG. 2.

### DESCRIPTION OF SPECIFIC EMBODIMENTS

An escalator 10 according to the invention has a step belt comprising a plurality of steps. Each step is guided on a rail 14 via a chain roller 12. Of course, running or tread rollers are provided in addition, and the chain rollers are mounted on both sides of the relevant step, even if just one chain roller 12 is illustrated here. The chain roller 12 is mounted in a freely rotatable manner on a chain pin 16, in particular via a rolling-contact bearing. It has a roller cover 18, as a kind of coating, on its outer circumference. The roller cover 18 encloses the roller core and, in the exemplary embodiment illustrated, is comprised of polyurethane. Its layer thickness here is 10% of the roller diameter.

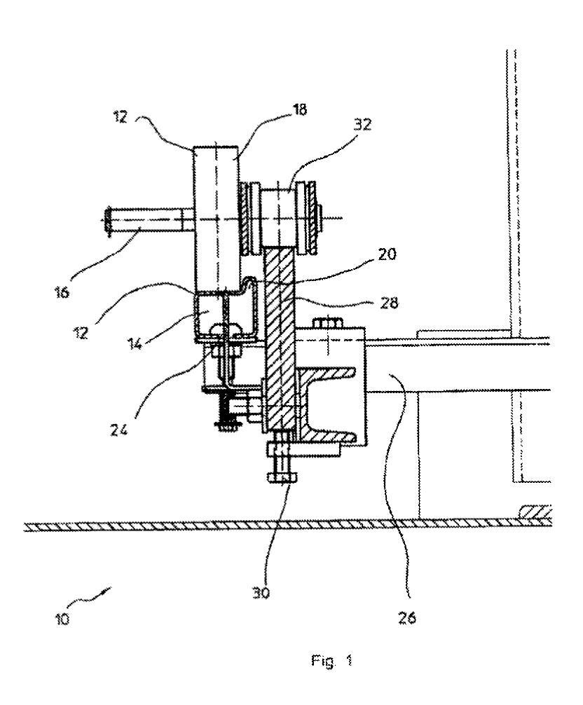

The rail 14 either is formed as a hollow profile or—as is illustrated in FIG. 1—is formed from bent sheet metal. It has a stop shoulder 20 toward the inside of the escalator and also a running surface 22, of which the width corresponds to that of the roller cover 18 and on which the roller cover runs.

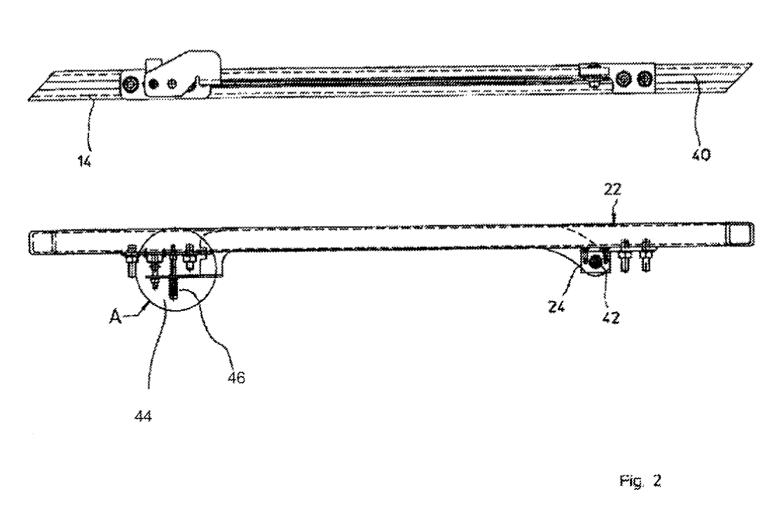

According to the invention, the running surface 22 is slotted approximately centrally and accommodates a distance sensor 24 there, this sensor extending along the rail 14 like a kind of blade. The configuration of the distance sensor 24 can be seen to better effect from FIG. 2.

Outside the region of the distance sensor, the rail 14 is not slotted and thus supports the chain rollers of the steps over the entire course of the escalator.

In the exemplary embodiment illustrated, the distance sensor according to the invention is installed in the return run of the escalator. However, it goes without saying that, in the same way, a corresponding distance sensor may instead be installed in the forward run of the escalator.

The rail 14 is supported on a further frame (not illustrated) of the escalator via a flange 26. The flange 26 also bears a curved supporting element 28 which extends, toward the inside of the escalator, to the side of the chain roller 12. The curved supporting element 28 is provided merely in the region of the distance sensor 24. It can be adjusted in terms of its vertical position via an adjusting screw 30 and supports the chain or step pin 16 to the side of the step or idling roller 12 via a guard roller 32. The height adjustment of the adjusting screw 30 takes place such that during normal operation, that is to say when the roller cover 18 of the chain roller 12 is not damaged, the chain roller 12 rests on the rail 14 and, at the same time, the guard or auxiliary roller 32 rests on the curved supporting element 28.

If a location of the roller cover 18 is then damaged, the curved supporting element 28, along with the auxiliary roller 32, assumes the supporting function in full, in which case the vertical position of the step pin 16 does not change.

The external diameter of the chain roller 12, however, is smaller at this location, in which case the rail 14, and thus the distance sensor 24, are briefly relieved of loading. This results in the distance sensor 24, which is spring-loaded in the upward direction, moving upwardly and thus being triggered.

Triggering causes the escalator to be switched off.

FIG. 2 shows the manner in which the distance sensor 24 can extend along the rail 14. The rail 14 is provided with a slot 40 in the region of the distance sensor.

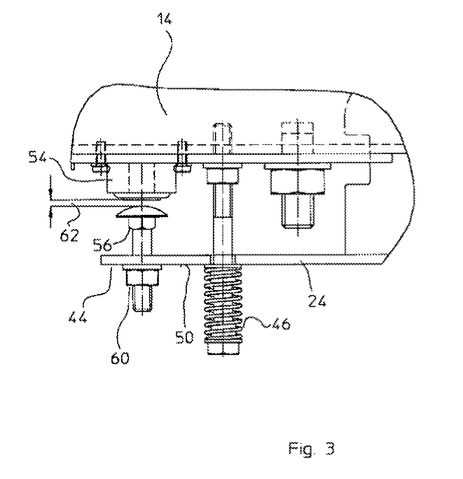

The distance sensor 24 is mounted on a bearing in the manner of a single-armed lever. It has a contact switch 44, which can be seen to better effect from FIG. 3.

The distance between the idling rollers of adjacent steps corresponds to the length of the distance sensor 24. This means that the distance sensor 24 is held down on a continuous basis by undamaged idling rollers or chain rollers, that is to say is not deflected vertically above the height of the running surface 22. It is only if there is a change in diameter as an idling roller runs on the distance sensor 2.4 that the distance sensor 24 is pushed upwardly, by the force of a compression spring 46, and the contact switch 44 is triggered.

It can be seen from FIG. 3 that the distance sensor 24 has an operating tongue 50 which serves for controlling the triggering operation. The exemplary embodiment illustrated provides for just one triggering threshold value, which is predetermined by the contact switch 44. The contact switch 44 comprises a rail-mounted contact 54 and a contact 56, which is mounted on the operating tongue. The contact 56 can be adjusted in terms of its vertical position via an adjusting screw 60, in which case the triggering threshold value can be adjusted.

When the distance sensor 24 is pushed down, that is to say extends in planar fashion in relation to the running surface 22, there is a nominal value for the distance 62 between the contacts 54 and 56 and, when the distance sensor 24 rises up by a corresponding amount, the contact 56 actuates the electrical contact 54, which results in the desired alarm being sounded.

Of course, it is also readily possible to provide instead for multi-stage signaling.

The specification incorporates by reference the disclosure of German priority document 20 2006 0094 83.0 filed May 31, 2006.

The present invention is, of course, in no way restricted to the specific disclosure of the specification and drawings, but also encompasses any modifications within the scope of the appended claims.

1. An escalator or moving walkway having a plurality of steps or panels that are respectively guided on rails via running rollers and idling rollers, comprising:
a distance sensor integrated in or on said rail.

2. An escalator or moving walkway according to claim 1, wherein said distance sensor is adapted to sense a deviation in diameter of a running roller or idling roller that runs over it.

3. An escalator or moving walkway according to claim 1, wherein said distance sensor is adapted to be pushed by said rollers essentially to a level of said rail.

4. An escalator or moving walkway according to claim 1, wherein said distance sensor extends parallel to said rail.

5. An escalator or moving walkway according to claim 4, wherein said distance sensor has a length that corresponds to a distance between rollers of adjacent steps or panels.

6. An escalator or moving walkway according to claim 1, wherein in a non-loaded state, said distance sensor projects beyond said rail in a direction toward a roller, and is adapted to be pushed down by said roller.

7. An escalator or moving walkway according to claim 6, wherein said distance sensor projects beyond said rail by a few millimeters.

8. An escalator or moving walkway according to claim 1, wherein said distance sensor is guided in a slot disposed over a given length of said rail, and wherein said distance sensor is yieldingly mounted in said slot for abutment against a roller.

9. An escalator or moving walkway according to claim 1, wherein a sensor holder is provided that is spaced from said rail by a diameter of the roller, wherein said distance sensor is guided on said sensor holder, and wherein ones of the rollers are intended for running between said sensor holder and said rail.

10. An escalator or moving walkway according to claim 1, wherein a switch is connected to said distance sensor.

11. An escalator or moving walkway according to claim 10, wherein said switch is part of a safety circuit of said escalator or moving walkway and, in the event of defective rollers, is adapted to switch said escalator or moving walkway off.

12. An escalator or moving walkway according to claim 1, wherein respective distance sensors are provided not only for said running rollers but also for said idling rollers.

13. An escalator or moving walkway according to claim 12, wherein a total of four distance sensors are provided for each escalator or moving walkway.

14. An escalator or moving walkway according to claim 1, wherein said distance sensor is pivotably mounted and has a length that is approximately equal to 1.1 times the distance between successive rollers.

15. An escalator or moving walkway according to claim 1, wherein said distance sensor is spring loaded in a direction of the roller that is to be checked, and with no roller present projects by 1 to 5 mm out of said rail.

16. An escalator or moving walkway according to claim 1, wherein with no roller present said distance sensor projects by approximately 2 mm out of said rail.
